(19) United States
(12) Patent Application Publication
(10) Pub. No.: US 2024/0070344 A1
(43) Pub. Date: Feb. 29, 2024

(54) REAL-TIME DRILLING OPTIMIZATION IN A METAVERSE SPACE

(71) Applicant: Landmark Graphics Corporation, Houston, TX (US)

(72) Inventors: Robello Samuel, Cypress, TX (US); David James Crawshay, Spring, TX (US); Abhishek Agrawal, (US)

(21) Appl. No.: 17/821,660

(22) Filed: Aug. 23, 2022

(51) Int. Cl. G06F 30/20; G06F 40/40; G06T 15/00

(52) U.S. Cl. CPC G06F 30/20; G06F 40/40; G06T 15/00; G06F 2111/18

(57) ABSTRACT

A system can be used for optimizing a wellbore operation via a metaverse space that can include one or more avatars. The system can provide access to the metaverse space for an entity. The metaverse space can be a computer-generated representation of a location relating to a wellbore operation. The system can receive, via an avatar in the metaverse space, a query from the entity relating to the wellbore operation. The avatar can include software applications for performing tasks in the metaverse space. The system can execute, via the avatar, a request to a micro-service for at least one solution parameter based on the query. The request can cause the micro-service to generate the at least one solution parameter. The system can receive the at least one solution parameter from the micro-service. The system can output the at least one solution parameter for adjusting the wellbore operation.

### TECHNICAL FIELD

The present disclosure relates generally to wellbore operations and, more particularly (although not necessarily exclusively), to optimizing wellbore operations using a metaverse space.

### BACKGROUND

A wellbore can be formed in a subterranean formation for producing or extracting fluid from the subterranean formation. The fluid can include hydrocarbon fluid such as oil and gas, etc. The wellbore can be formed or used via one or more wellbore operations such as a drilling operation, a completion operation, a production operation, etc. The wellbore operations can involve one or more parameters. For example, a drilling operation can involve parameters such as a weight on a drill bit, revolutions per minute (RPM) of the drill bit, or drilling fluid flow rate. Determining parameters to use for the wellbore operations can be difficult in some instances, for example if engineering services or other resources are not available.

### BRIEF DESCRIPTION OF THE DRAWINGS

FIG. 1 is a schematic of a wellbore that can undergo a drilling operation according to one example of the present disclosure.

FIG. 2 is a block diagram of a computing device for optimizing wellbore operations using a metaverse space according to one example of the present disclosure.

FIG. 3 is a flowchart of a process for optimizing wellbore operations using a metaverse space according to one example of the present disclosure.

FIG. 4 is a workflow diagram of a workflow for optimizing wellbore operations using a metaverse space according to one example of the present disclosure.

FIG. 5 is an example of a metaverse space that can be used to optimize a wellbore operation according to one example of the present disclosure.

FIG. 6 is an additional example a metaverse space that can be used to optimize a wellbore operation according to one example of the present disclosure.

### DETAILED DESCRIPTION

Certain aspects and examples of the present disclosure relate to a metaverse space that can be used to optimize a wellbore operation. For example, parameters of the wellbore operation can be optimized in the metaverse space, and a wellbore operation, such as a drilling operation, can be adjusted (e.g., in real-time) based on the optimized parameters. The metaverse space can be a computer-generated universe or space. In some examples, the metaverse space can include or represent a virtual real-time operating center, a virtual rig, a virtual office space, a virtual conference room, additional virtual space related to the wellbore operation, or a combination thereof. Additionally, the metaverse space can provide access to an entity for use in optimizing the wellbore operation. The entity can include a user, such as an engineer, an operator, a manager, and the like, or other suitable entity that can access the metaverse space. The entity may access the metaverse space via virtual reality technology, augmented reality technology, or the like. The wellbore operation can include a drilling operation, a completion operation, a stimulation operation, a production operation, an abandonment operation, or any other suitable operations with respect to a wellbore. In some examples, the metaverse space can provide parameters related to the wellbore operation, or the metaverse space can be used to predict optimized parameters, monitor the wellbore operation, or simulate scenarios related to the wellbore operation. Additionally, the metaverse space can generate an output that can include the parameters, the optimized parameters, or other suitable information related to the wellbore operation. The wellbore operation can be controlled or adjusted by the entity based on the output in the metaverse space to optimize the wellbore operation. For example, the rotation speed for a drill bit in a drilling operation can be adjusted to an optimal rotation speed based on the output in the metaverse space. In some examples, the wellbore operation may be adjusted or controlled automatically based on the output in the metaverse space to optimize the wellbore operation.

Techniques involving a metaverse space can involve predicting or optimizing parameters for various wellbore operations using the metaverse space. The techniques can also involve using the metaverse space for determining optimal control parameters for the various wellbore operations. The parameters can be used for real-time, closed-loop control of the various wellbore operations. In some examples, advice relating to the wellbore operations can be provided through avatars in the metaverse space, which may include software modules, such as bots (e.g., pre-programmed chat bots), or other suitable entities that can be represented by an avatar. Augmented reality, virtual reality (AR/VR), and the like can be used to access the metaverse space. The AR/VR can be combined with engineering micro-services and real-time data to predict and prescribe solution parameters for the wellbore operations. Additionally, the engineering micro-services can be connected to the metaverse space to interact with engineering input for prediction. The techniques may involve physics-based models, data-science models, uncertainty-based models, other suitable models, or any suitable combination thereof.

The metaverse space can include or represent a network of three-dimensional virtual rigs, offices, or the like in which engineers, users, or other suitable entities can provide solutions, interact with other engineers, users, or other suitable entities in the real world and in the metaverse space through avatars. Scenarios for a wellbore operation can be generated, solutions for the wellbore operation can be predicted, etc. via the metaverse space. The metaverse space can also be used to monitor the wellbore operation in real-time. Additionally, the wellbore operation can be controlled or adjusted in the real-world based on information or output from the metaverse space. For example, a predicted parameter for the wellbore operation can be based on a solution or a scenario generated in the metaverse space and the predicted parameter can be implemented, in real-time, in the wellbore operation to improve the efficiency of the wellbore operation.

The metaverse space can use coupled models, such as physics-based models, data-science models, uncertainty-based models, and the like to facilitate outputting optimized parameters for use in a wellbore operation. In some examples, the coupled models can be interfaced with blockchain technology, crypto wallets, and the like to provide security from malicious entities. The metaverse space can operate on a modular, open architecture principle, which allows a metaverse real-time center to be at least communicatively coupled with external metaverse spaces. The metaverse space can provide a variety of functions or other suitable operations, including integration with existing or new real-time management systems, communication systems, navigation systems, surveillance systems, and the like with respect to the wellbore operations. A core engine of the metaverse space can offer flexible interoperability and enhanced user experiences. For example, the metaverse space can provide customizable engineer avatars that can jump between metaverse spaces using blockchain technology and crypto wallets, etc.

The metaverse space can provide access to the metaverse space to the entity upon authenticating the entity. The metaverse space can receive, via one or more avatars in the metaverse space, a query from the entity relating to the wellbore operation. In some examples, the query can include a request for optimized parameters that can be used to optimize the wellbore operation. The metaverse space can, based on the query, execute one or more application programming interface calls to one or more micro-services, engineering models, or the like, causing the one or more micro-services, engineering models, or the like to generate a solution to the query. The metaverse space can receive, from the one or more micro-services, the engineering models, etc., the solution. For example, the solution can be an optimized parameter for a drilling operation. The metaverse space can output the optimized parameter and the drilling operation can be adjusted based on the output. The metaverse space can further provide predictions, simulations, advice, additional parameters, or other suitable information relating to the wellbore operation. The metaverse space can be used optimize a variety of wellbore operations including, a completion operation, a stimulation operation, a production operation, an abandonment operation, or any other suitable operations with respect to a wellbore.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

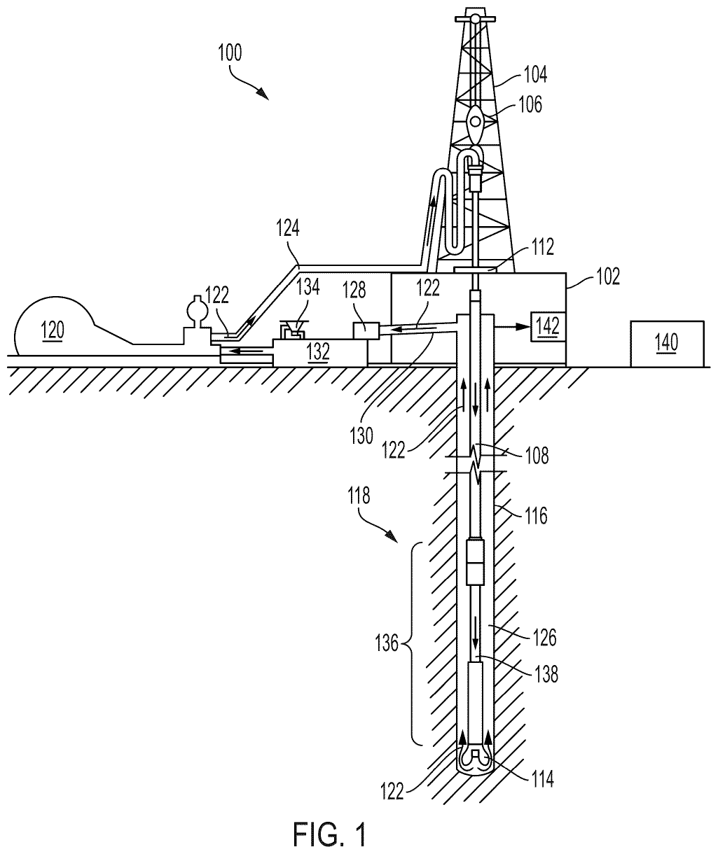

FIG. 1 is a schematic of a wellbore 116 that can undergo a wellbore operation according to one example of the present disclosure. In some examples, the wellbore operation can be a drilling operation. As illustrated, a drilling system 100 may include a drilling platform 102 that supports a derrick 104 having a traveling block 106 for raising and lowering a drill string 108. The drill string 108 may include drill pipe and coiled tubing. A kelly 110 can support the drill string 108 as it is lowered through a rotary table 112. A drill bit 114 can be attached to the downhole end of the drill string 108 and can be driven by a downhole motor, by rotation of the drill string 108, and the like from the well surface. As the drill bit 114 rotates, the drill bit 114 can penetrate various subterranean formations 118 to create the wellbore 116.

While FIG. 1 depicts a drilling operation, the principles and techniques described herein can be applied to a completion operation, a stimulation operation, a production operation, an abandonment operation, or any other suitable operations with respect to a wellbore. Additionally, while FIG. 1 generally depicts a land-based drilling assembly, the principles described herein are similarly applicable to subsea drilling operations. The principles may also be applicable to other forms of drilling, managed pressure drilling, underbalanced drilling, and the like.

A pump 120 (e.g., a mud pump) can circulate a fluid 122 through a feed pipe 124 and into the interior of the drill string 108. In some examples, the fluid 122 may be a drilling fluid or the fluid 122 can be any other type of fluid that may be circulated through the wellbore 116, produced at the surface at or near the drilling platform 102, or sampled downhole and subsequently provided to the fluid extraction system 142. For instance, the fluid 122 may similarly apply to reservoir fluids, gases, oils, water, and any other fluid that may be produced from the wellbore 116. Additionally, the drilling system 100 may similarly be replaced or otherwise equated with any suitable wellbore fluid extraction system such as a wellhead installation used to produce fluids to the surface.

In the drilling system 100, the fluid 122 may be conveyed via the drill string 108 to the drill bit 114 and out at least one cavity in the drill bit 114. Then, the fluid 122 can be circulated back to the surface via an annulus 126 defined between the drill string 108 and a wall of the wellbore 116. At the surface, the recirculated or spent fluid 122 can exit the annulus 126 and may be conveyed to one or more fluid processing unit(s) 128 via a fluid return line 130. After passing through the fluid processing unit(s) 128, a “cleaned” fluid 122 can be deposited into a retention pit 132 (i.e., a mud pit). One or more chemicals, fluids, or additives may be added to the fluid 122 via a mixing hopper 134 communicably coupled to or otherwise in the fluid communication with the retention pit 132.

The drilling system 100 may further include a bottom hole assembly (BHA) 136 arranged in the drill string 108 at or near the drill bit 114. The BHA 136 may include any of a number of sensor modules 138 (one illustrated, but two, three, four, or more are possible) which may include formation evaluation sensors and directional sensors, such as measuring-while-drilling or logging-while-drilling tools. The sensor modules 138 can collect data relating to the wellbore 116 or drilling operation, which can be received by a computing device 140. The data from the sensor modules 138 can be used by micro-services, engineering models, or the like to determine parameters relating to the drilling operation or the wellbore 116. Parameters can include well trajectory, inclination, pore pressure, diameter of the drill bit 114, penetration speed, etc.

An operator or other suitable user related to the drilling operation performed by the drilling system 100 can receive access to a metaverse space via computing device 140. The operator or other suitable user can provide a query related to the drilling operation to an avatar in the metaverse space. For example, the query can be a request for an optimal operational parameter, such as RPM of the drill bit 114. The avatar in the metaverse space can generate a request to a micro-service or engineering model for a solution to the query, and the micro-service or engineering model can determine the solution based on the data collected by the sensor modules 138. The solution can be transmitted to the avatar for output in the metaverse space. The drilling operation can be controlled or adjusted based on the output in the metaverse space. For example, the metaverse space can predict the optimal RPM of the drill bit 114 for the drilling operation and the optimal RPM of the drill bit 114 can be an output in the metaverse space for the operator or other suitable user to view or otherwise consume. The operator or other suitable user can adjust the drilling operation to implement the optimal RPM of the drill bit 114. In some examples, the optimal RPM of the drill bit 114 may be adjusted automatically, such as by an autonomous drilling system, the computing device 140, etc., based on the output in the metaverse space.

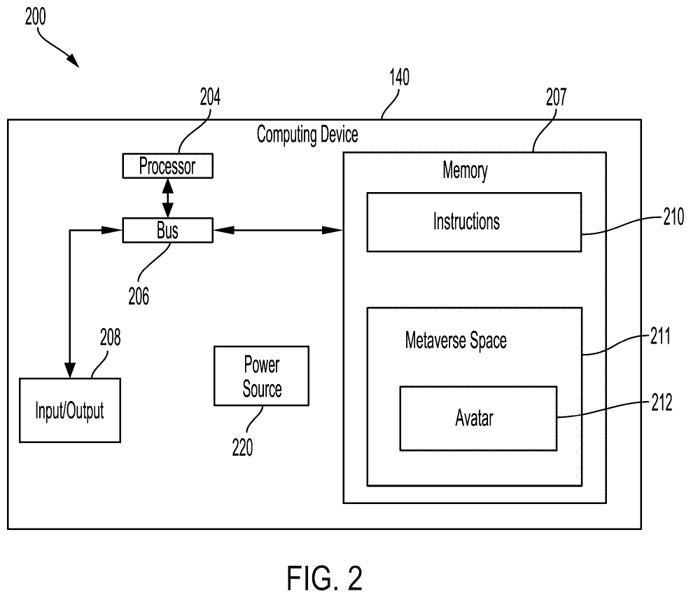

FIG. 2 is a block diagram 200 of a computing device 140 for optimizing wellbore operations using a metaverse space 211 according to one example of the present disclosure. The components shown in FIG. 2, such as the processor 204, memory 207, power source 220, input/output 208, and the like may be integrated into a single structure such as within a single housing of a computing device 140. Alternatively, the components shown in FIG. 2 can be distributed from one another and in electrical communication with each other. Additionally, while the metaverse space 211 is illustrated as being provided by or otherwise included in the computing device 140, in other examples, the computing device 140 can be communicatively coupled to a separate computing device or system that can provide access to the metaverse space 211.

The computing device 140 can include a processor 204, a memory 207, and a bus 206. The processor 204 can execute one or more operations for determining optimal tripping operation parameters using one or more optimization models subject to one or more constraints. The processor 204 can execute instructions 210 stored in the memory 207 to perform the operations. The processor 204 can include one processing device or multiple processing devices or cores. Non-limiting examples of the processor 204 include a Field-Programmable Gate Array (“FPGA”), an application-specific integrated circuit (“ASIC”), a microprocessor, etc.

The processor 204 can be communicatively coupled to the memory 207 via the bus 206. The non-volatile memory 207 may include any type of memory device that retains stored information when powered off. Non-limiting examples of the memory 207 may include EEPROM, flash memory, or any other type of non-volatile memory. In some examples, at least part of the memory 207 can include a medium from which the processor 204 can read instructions 210. A computer-readable medium can include electronic, optical, magnetic, or other storage devices capable of providing the processor 204 with computer-readable instructions or other program code. Nonlimiting examples of a computer-readable medium include (but are not limited to) magnetic disk(s), memory chip(s), ROM, RAM, an ASIC, a configured processor, optical storage, or any other medium from which a computer processor can read instructions 210. The instructions 210 can include processor-specific instructions generated by a compiler or an interpreter from code written in any suitable computer-programming language, including, for example, C, C++, C#, Perl, Java, Python, etc.

In some examples, the memory 207 can be a non-transitory computer readable medium and can include computer program instructions 210. For example, the computer program instructions 210 can be executed by the processor 204 for causing the processor 204 to perform various operations. For example, the processor 204 can provide access to a metaverse space 211 for an entity. The entity can be a user, such as an engineer, an operator, a supervisor, or other suitable entity that can access the metaverse space 211. The processor 204 can provide access to the metaverse space 211 via augmented reality technology, virtual reality technology, or the like, which can include a virtual rig, a virtual real-time operating center, or other suitable virtual spaces related to the wellbore operation. The metaverse space 211 can include one or more avatars 212. The one or more avatars 212 can be one or more software applications programmed to perform tasks in the metaverse space 211. Additionally or alternatively, the one or more avatars 212 can be automated such that the one or more avatars 212 can operate according to software instructions without external input.

The entity can provide a query to the one or more avatars 212 relating to the wellbore operation, which can be processed into an input ingestible by the one or more avatars 212 using natural language processing, etc. The input can be transmitted to one or more micro-services, engineering models, or the like via one or more application programming interface calls to request a solution to the query. The solution to the query can be transmitted from the micro-service, engineering model, etc. to the one or more avatars 212 and displayed as an output in the metaverse space 211 or otherwise suitably for use in optimizing the wellbore operation.

The computing device 140 can additionally include an input/output 208. The input/output 208 can connect to a keyboard, a pointing device, a display, other computer input/output devices or any combination thereof. An operator may provide input using the input/output 208. Data relating to the wellbore 116, the wellbore operation, or a combination thereof can be displayed to an operator of a wellbore operation through a display that is connected to or is part of the input/output 208. The displayed values can be observed by the operator, or by another suitable user, of the wellbore operation, who can adjust the wellbore operation based on the output in the metaverse space 211. Additionally or alternatively, the computing device 140 can automatically control or adjust the wellbore operation based on the output in the metaverse space 211.

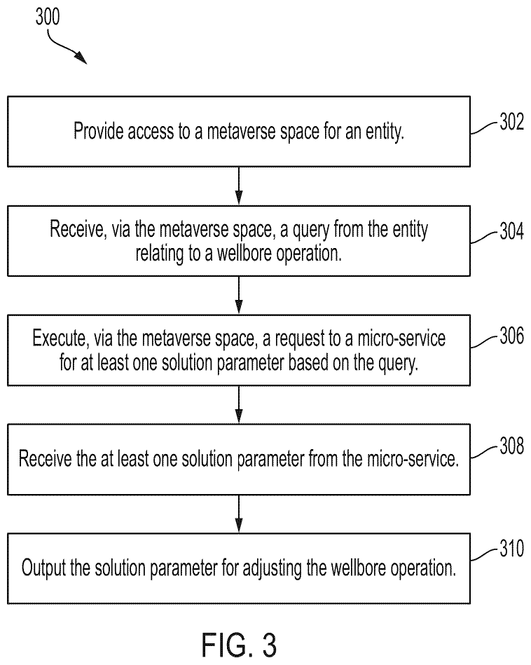

FIG. 3 is a flowchart of a process 300 for optimizing wellbore operations using a metaverse space 211 according to one example of the present disclosure. The wellbore operation can include a drilling operation, a completion operation, a stimulation operation, a production operation, an abandonment operation, or any other suitable operations with respect to a wellbore. The metaverse space 211 can include a computer-generated representation of a network of three-dimensional virtual rigs, real-time operating centers, or offices that can be accessed by an entity via virtual reality, augmented reality, or the like. The metaverse space 211 can use coupled models, such as physics-based models, data-science models, uncertainty-based models, and or other suitable engineering models to provide information for use in optimizing the wellbore operations.

At block 302, the computing device 140 provides access to the metaverse space 211 for the entity. The entity may be a user, such as an engineer, an operator, a supervisor, a crew member, a customer, or other suitable entity related to the wellbore operation. The metaverse space 211 can include a three-dimensional virtual rig, a virtual office, a virtual real-time operating center, a virtual conference room, or other suitable spaces related to the wellbore operation and the metaverse space 211 can include one or more avatars 212. The entity can access the metaverse space 211, interact with the one or more avatars 212, or a combination thereof via augmented reality technology, virtual reality technology, or the like.

In some examples, the metaverse space 211 can use coupled models, such as physics based, data science, uncertainty-based, and the like, which can be interfaced with blockchain technology, crypto wallets, etc. to provide security from malicious entities. For example, access to a particular metaverse space can be provided to a particular entity via a blockchain by partitioning data for access by the particular entity and generating the particular metaverse space to include the partitioned data. The particular entity may access the particular metaverse space via an authentication process, in which the particular entity may provide an authorization credential. The technique of using blockchain, crypto wallets, or other suitable technology to secure data, requiring an authentication process, or a combination thereof can prevent malicious or unwanted entities from accessing the secured data. Additionally, the one or more avatars 212 may be able to jump between metaverse spaces using blockchain technology, crypto wallets, etc.

At block 304, the computing device 140 receives, via an avatar in the metaverse space 211, a query from the entity relating to the wellbore operation. The avatar can include a software application for performing tasks in the metaverse space. The metaverse space can include a computer-generated representation of a location related to the wellbore operation. The metaverse space can connect data from a real-world wellbore operation to a micro-service to optimize the availability of optimized parameters and other suitable information in the metaverse space for access by the entity. Additionally, the entity accessing the metaverse space can be in a real-world location relating to the wellbore operation.

In some examples, the query can include a request for optimized parameters relating to the wellbore operation. The entity can transmit the query to the one or more avatars 212 via augmented reality technology, virtual reality technology, or the like by speaking, typing, or otherwise communicating the query in the metaverse space 211. Natural language processing can be used to comprehend the query and process the query into an input that can be ingested by the one or more avatars 212. The input ingested by the one or more avatars 212 can be used to determine which micro-service, engineering model, etc. to access for the optimized parameters or other suitable solution relating to the input.

At block 306, the computing device 140 executes, via the metaverse space 211, a request to the micro-service for at least one solution parameter based on the query. The request can be transmitted from the one or more avatars 212 to one or more micro-services, engineering models, or the like. Additionally, the request can include one or more application programming interface calls based on the input ingested the one or more avatars 212, which is based on the query from the entity. The request can include a request for optimized control parameters, optimized operational parameters, or additional parameters related to the wellbore operation. The micro-service, engineering model, or the like can perform calculations, access real-time data, predict solutions, or perform additional operations in relation to the request to determine the at least one solution parameter. Real-time data from the wellbore operation can be provided to the micro-service via the metaverse space from sensor modules 138 or other downhole tools.

At block 308, the computing device 140 receives, via the metaverse space, the at least one solution parameter from the micro-service. The solution parameter can be output from the micro-service, engineering model, or the like and can be transmitted to the one or more avatars 212 in the metaverse space 211. The solution parameter can provide an answer to the query, a prediction, advice, or other useful information for optimizing the wellbore operation. In some examples, the solution parameter can be related to a real-time wellbore operation and can include optimized operational parameters, optimized control parameters, real-time data, parameter predictions, or any other suitable data or parameters relating to the wellbore operation. The wellbore operation can be optimized in real-time based on the solution parameter received by the metaverse space.

At block 310, the computing device 140 outputs the solution parameter for display in the metaverse space. The one or more avatars 212 can receive the solution parameter from the micro-service, generate an output with the solution parameter, and provide the output with the solution parameter in the metaverse space 211 for the entity. The output with the solution parameter can be provided, for example by displaying the solution parameter proximate to the one or more avatars 212. For example, the output can be displayed visually as a sentence, graph, number, table, or other suitable display in an area of the metaverse near an avatar such as above an avatar's head, to the left or right of an avatar, or below the avatar near an avatar's feet. In additional examples, the output with the solution parameter can be displayed anywhere in the metaverse space 211 or otherwise communicated to the entity. For example, the output for the solution parameter can be provided auditorily. The metaverse space 211 can further provide an output to the entity by simulating a wellbore operation using optimized parameters.

Additionally, the at least one solution parameter can be used to adjust the wellbore operation. For example, the entity can be an operator than can adjust the wellbore operation in real-time based on the solution parameter provided in the metaverse space 211. In some examples, the at least one solution parameter can be used for real-time, autonomous control of the wellbore operation. Autonomous control of the wellbore operation can include receiving the solution parameter in the metaverse space 211, determining an adjustment to the wellbore operation based on the solution parameter, and automatically making the adjustment to the wellbore operation.

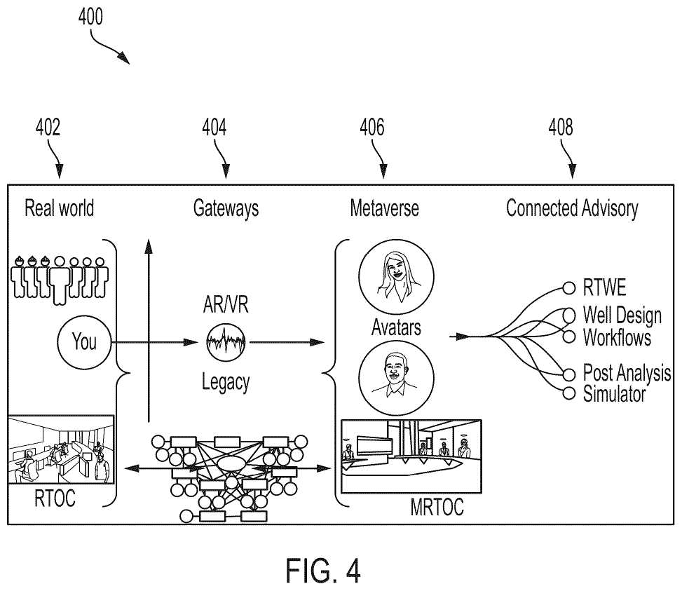

FIG. 4 is a workflow diagram of a workflow 400 for optimizing wellbore operations using a metaverse space 211 according to one example of the present disclosure. The metaverse space 211 can provide optimized parameters for the wellbore operation or additional information that can be used for real-time control of the wellbore operation. The metaverse space 211 can connect engineers, operators, and additional users related to the wellbore operation to micro-services, engineering models, and the like via communication with one or more avatars 212 in the metaverse space 211. The metaverse space 211 can be a computer-generated representation of a real-world location, such as a rig or real-time operating center. In some examples, the metaverse space 211 can be a computer-generated representation of a pseudo real-world location. For example, a real-time operating center may be a real-world location that exists in the metaverse space 211 rather than the real-world, which can minimize costs and resources for performing the wellbore operations.

At block 402, an entity is in a real-world scenario. The entity can be an operator, a supervisor, an engineer, or other user related to the wellbore operations. The real-world scenario can be in a location of the wellbore operation, in a real-time operating center related to the wellbore operation, the entity's home, or any other scenario the entity may be in while accessing the metaverse space 211. The metaverse space 211 can provide quick access for the one or more entities and can connect one or more entities to one another or to the one or more avatars 212. The metaverse space 211 can further be a computer-generated representation of the real-world scenario or another suitable real-world scenario. The metaverse space 211 thereby improves the efficiency of wellbore operations and decreases resources for performing wellbore operations. Resources can be decreased as less office space or real-time operating centers in the real-world may be used to operate the wellbore operation.

At block 404, the computing device 140 provides the entity access to the metaverse space 211 via one or more gateways. The metaverse space can be a computer-generated location related to the wellbore operation. The one or more gateways can be provided by virtual reality technology, augmented reality technology, traditional computing devices, or the like. For example, the entity may use a virtual reality head set communicatively coupled to the computing device 140 to access the metaverse space 211 via the virtual reality technology. The computing device 140 may use blockchain technology, crypto wallets, or other suitable technologies to provide secure access for the entity to the metaverse space 211 at the one or more gateways. Further, blockchain technology can be used to securely exchange data between one or more entities. In some examples, a subset of data can be partitioned and a metaverse space 211 can be generated for providing access to the subset of data for a particular entity. The computing device 140 can receive an authorization credential from the particular entity for providing the particular entity access to a gateway for the metaverse space 211 with the subset of data.

At block 406, the computing device 140 generates or otherwise provides access to the metaverse space 211. The metaverse space 211 can be a virtual real-time operating center, a virtual rig, or other virtual space related to the wellbore operation. The metaverse space 211 can include one or more avatars 212, which can be one or more software applications capable of accessing micro-services, engineering models, or additional resources related to the wellbore operation. Additionally, the one or more avatars 212 can perform tasks in the metaverse space 211. For example, an avatar 212 may simulate an operator in a real-time operating center. An engineer or other suitable entity may ask the avatar 212 for a parameter or other information related to the wellbore operation. The avatar 212 can access a microservice, engineering model, or other suitable resource, receive a solution from the microservice, engineering model, or other suitable resource, and the solution can be an output in the metaverse near the avatar 212. Thus, the engineer or other suitable entity may be able to obtain information faster and less resources may be used to provide the engineer or other suitable entity with the parameter or additional information related to the wellbore operation. In some examples, the avatar 212 may access one micro-service. Therefore, the avatar 212 may be an expert in one aspect of the wellbore operation such as one parameter. In other examples, the avatar 212 may access a variety of micro-services for providing a variety of information relating to the wellbore operation to the entity. Additionally, the metaverse space 211 may include a simulation of the wellbore operation and may use parameters obtained from the micro-service or other suitable resource to generate the simulation.

At block 408, the computing device 140 provides the metaverse space 211 access to a connected advisory of tasks or resources relating to the wellbore operation. The tasks may include post analysis of the wellbore operation, simulation of the wellbore operation, well design planning, or other suitable tasks. The resources may include real-time well engineering models, well design data, pre-existing workflows, or other suitable resources related to the wellbore operation. The entity may provide a query to the one or more avatars 212 by speaking, typing, or otherwise communicating the query. Natural language processing can be performed on the query to generate an input that can be understood by the one or more avatars 212. The one or more avatars 212 can determine the task or the resource to provide a solution to the input. Furthermore, the one or more avatars 212 can determine a micro-service, engineering model, or the like for generating the solution. The one or more avatars 212 can receive the solution and output the solution as a number, graph, sentence, table, or other suitable display. In some examples, the avatar 212 may provide a task, such as a simulation, in the metaverse space 211 in response to the query. Additionally, the connected advisory can be specific to a type of wellbore operation such as a completion operation, a stimulation operation, a production operation, an abandonment operation, or any other suitable operations.

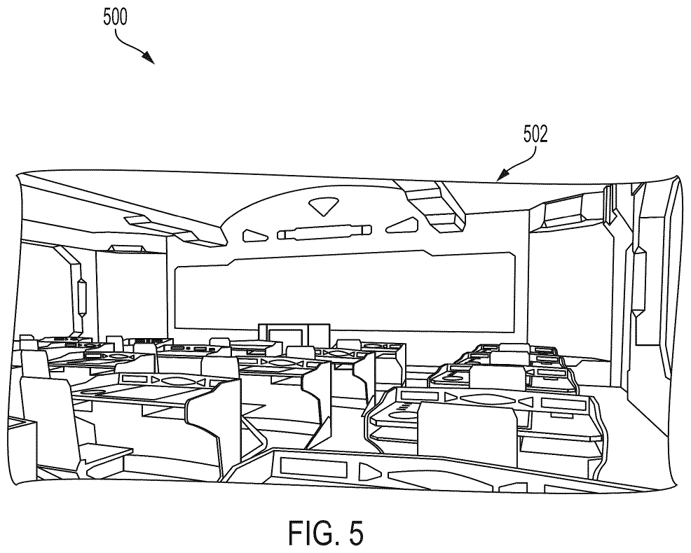

FIG. 5 is an example of a metaverse space 500 according to one example of the present disclosure. The metaverse space 500 can be a virtual room 502. The virtual room 502 can be a virtual real-time operating center, a virtual office, a virtual conference room, or other suitable space. Additionally, although not illustrated, the virtual room 502 can in include one or more avatars 212. The virtual room 502 can be used for conferences, meetings, seminars, or other suitable events in which one or more entities related to the wellbore operation can interact in the metaverse space. The one or more entities may be engineers, crew members, operators, or other suitable entities that can enter the virtual room 502 via virtual reality technology, augmented reality technology, or the like. The one or more entities, the one or more avatars 212, or a combination thereof can move around, navigate, interact, or perform other suitable tasks within the virtual room 502.

Additionally, the one or more entities may interact with the one or more avatars 212 by providing a query by speaking, typing, other otherwise communicating the query to the one or more avatars 212 in the virtual room 502. The query can be a request for an optimized parameter relating to the wellbore operation or other suitable request for information related to the wellbore operation. Natural language processing can be performed on the query to generate an input that can be understood by the one or more avatars 212. The one or more avatars 212 can perform application programming interface calls to micro-services, engineering models, or the like based on the input generated by natural language processing. The micro-services, engineering models, or the like can generate a solution to the query and transmit the solution to the one or more avatars 212. The solution can be output in the virtual room 502 or other suitable metaverse space and can be used to optimize the wellbore operation.

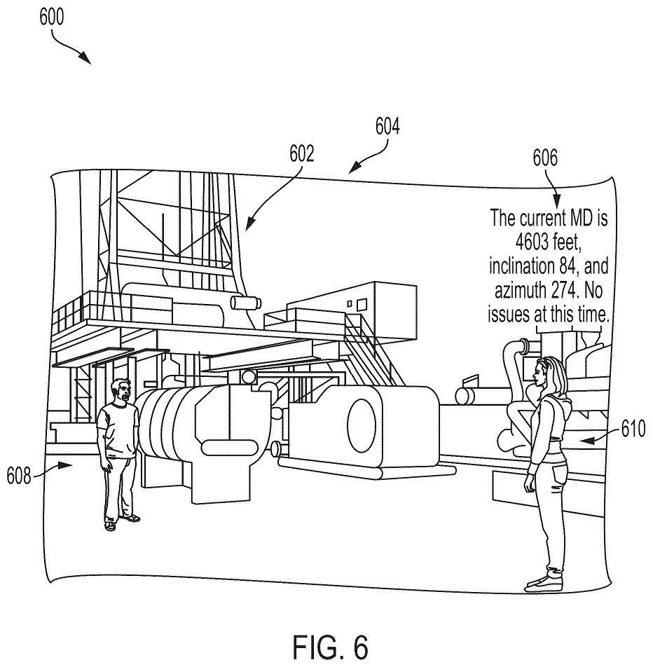

FIG. 6 is an example of an output displayed in a metaverse space according to one example of the present disclosure. The metaverse space 600 can be a location of a wellbore operation 604 including a virtual rig 602. The wellbore operation performed at the location of the wellbore operation 604 may be a include a drilling operation, a completion operation, a stimulation operation, a production operation, an abandonment operation, a tripping operation, or any other suitable operations. The metaverse space 600 can in include an avatar 610 and an entity avatar 608 representing an entity accessing the metaverse space. Although one avatar 610 and one entity avatar 608 is illustrated, the metaverse space 600 may include more than one avatar 610, more than one entity avatar 608, or a combination thereof. The entity avatar 608 can be representative of an operator, engineer, or other suitable entity that can access the metaverse space via virtual reality technology, augmented reality technology, or the like. The metaverse space 600 can be used for simulating wellbore operations, predicting optimized parameters, monitoring the wellbore operation, or other suitable tasks related to the wellbore operation. The entity avatar 608, the avatar 610, or a combination thereof may move around, navigate, interact, or perform other suitable tasks within the location of the wellbore operation 604.

The entity avatar 608 may provide a query to the avatar 610 by speaking, typing, other otherwise communicating the query. The query can be a request for an optimized parameter, current parameters, advice, scenarios, or other suitable requests related to the wellbore operation. The avatar 610 may be a software application that runs automated tasks. In some examples, the avatar 610 may be a software application for accessing a subset of micro-services relating to one or few aspects of the wellbore operation. In other examples, the avatar 610 may be software application for accessing a variety of micro-services, engineering models, relating to many aspects of the wellbore operation. Thus, in some examples the avatar 610 may be able to provide a solution to a query based on one or few aspects of the wellbore operation or the avatar 610 may be able to provide a solution to a query based on many aspects of the wellbore operation.

Additionally, natural language processing can be performed on the query to generate an input that can be ingested by avatar 610. The avatar 610 can perform one or more application programming interface calls to one or more micro-services, engineering models, or the like based on the input generated by natural language processing. The one or more micro-services, engineering models, or the like can generate a solution to the query and transmit the solution to the avatar 610. Output 606 can be the solution to the query and the wellbore operation can be adjusted or controlled based on the output 606. The output 606 can be position proximate to the avatar 610 in the metaverse space 600. As illustrated, the output 606 indicates that there are no issues with the wellbore operation. In some examples, output 606 can alert the entity avatar 608 to a problem with the wellbore operation and can further include advice or optimized parameters for improving the wellbore operation. The entity represented by entity avatar 608 can manually adjust the wellbore operation or the wellbore operation can be automatically adjusted based on output 606 to improve or optimize the wellbore operation.

In some aspects, systems, methods, or non-transitory computer-readable mediums for optimizing a wellbore operation in a metaverse space are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is a system comprising: a processor; and a non-transitory computer-readable medium that includes instructions executable by the processor for causing the processor to perform operations comprising: receiving, via an avatar in a metaverse space, a query from an entity relating to a wellbore operation, the avatar including a software application for performing tasks in the metaverse space, the metaverse space including a computer-generated representation of a location related to the wellbore operation, the metaverse space usable to communicatively couple data from a real-world wellbore operation and at least one micro-service; executing, via the avatar, a request to the at least one micro-service for at least one solution parameter for the wellbore operation based on the query; receiving, via the metaverse space, the at least one solution parameter from the at least one micro-service; and outputting the at least one solution parameter for display in the metaverse space, the at least one solution parameter usable to adjust the wellbore operation.

Example 2 is the system of example 1, wherein the operation of executing, via the avatar, the request to the at least one micro-service for the at least one solution parameter further comprises: providing, via the metaverse space, real-time data of the wellbore operation to the at least one micro-service for predicting at least one optimized parameter relating to the wellbore operation; and simulating, via the metaverse space, at least one scenario relating to the wellbore operation.

Example 3 is the system of example 1, further comprising the operation of providing access to the metaverse space for the entity by: providing access to the metaverse space via virtual reality technology or augmented reality technology; and generating, via the virtual reality technology or the augmented reality technology, a virtual rig or a virtual office, wherein the virtual rig or the virtual office includes at least one avatar.

Example 4 is the system of any of examples 1 and 3, wherein the operations further comprise providing access to the metaverse space for the entity using a blockchain by: partitioning at least one set of data for access by a particular entity; generating a particular metaverse space, the particular metaverse space including the at least one set of data; and providing, via an authentication process, access to the particular metaverse space and the at least one set of data for the particular entity, wherein the authentication process includes the particular entity providing an authorization credential and permitting the particular entity to enter to the particular metaverse space.

Example 5 is the system of example 1, wherein the operation of receiving, via the avatar in the metaverse space, the query further comprises: performing natural language processing on the query for generating an input ingestible by the avatar in the metaverse space; transmitting the input ingestible by the avatar from the entity to the avatar in the metaverse space; transmitting the input ingestible by the avatar from the avatar in the metaverse space to the at least one micro-service; and determining the at least one micro-service to access based on the input ingestible by the avatar.

Example 6 is the system of any of examples 1 and 5, wherein the operation of executing, via the avatar, the request to the at least one micro-service for the at least one solution parameter further comprises: transmitting, via an application programming interface, the request from the avatar to the micro-service based on the input ingestible by the avatar; and receiving the at least one solution parameter based on an output from the micro-service.

Example 7 is the system of example 1, wherein the operation of outputting the at least one solution parameter for display in the metaverse space further comprises displaying, for the entity, the at least one solution parameter proximate to the avatar in the metaverse space.

Example 8 is the system of example 1, further comprising the operation of adjusting the wellbore operation autonomously by: receiving the at least one solution parameter via the metaverse space, determining an adjustment to the wellbore operation based on the at least one solution parameter; and adjusting the wellbore operation based on the adjustment.

Example 9 is a method comprising: receiving, via an avatar in a metaverse space, a query from an entity relating to a wellbore operation, the avatar including a software application for performing tasks in the metaverse space, the metaverse space including a computer-generated representation of a location related to the wellbore operation, the metaverse space usable to communicatively couple data from a real-world wellbore operation and at least one micro-service; executing, via the avatar, a request to the at least one micro-service for at least one solution parameter for the wellbore operation based on the query; receiving, via the metaverse space, the at least one solution parameter from the at least one micro-service; and outputting the at least one solution parameter for display in the metaverse space, the at least one solution parameter usable to adjust the wellbore operation.

Example 10 is the method of example 9, wherein executing, via the avatar, the request to the at least one micro-service for the at least one solution parameter further comprises: providing, via the metaverse space, real-time data of the wellbore operation to the at least one micro-service for predicting at least one optimized parameter relating to the wellbore operation; and simulating, via the metaverse space, at least one scenario relating to the wellbore operation.

Example 11 is the method of example 9, further comprising providing access to the metaverse space for the entity by: providing access to the metaverse space via virtual reality technology or augmented reality technology; and generating, via the virtual reality technology or the augmented reality technology, a virtual rig or a virtual office, wherein the virtual rig or the virtual office includes at least one avatar.

Example 12 is the method of any of examples 9 and 11, further comprising providing access to the metaverse space for the entity using a blockchain by: partitioning at least one set of data for access by a particular entity; generating a particular metaverse space, the particular metaverse space including the at least one set of data; and providing, via an authentication process, access to the particular metaverse space and the at least one set of data for the particular entity, wherein the authentication process includes the particular entity providing an authorization credential and permitting the particular entity to enter to the particular metaverse space.

Example 13 is the method of example 9, wherein receiving, via the avatar in the metaverse space, the query from the entity further comprises: performing natural language processing on the query for generating an input ingestible by the avatar in the metaverse space; transmitting the input ingestible by the avatar from the entity to the avatar in the metaverse space; transmitting the input ingestible by the avatar from the avatar in the metaverse space to the micro-service; and determining the micro-service to access based on the input ingestible by the avatar.

Example 14 is the method of any of examples 9 and 13, wherein executing, via the avatar, the request to the at least one micro-service for the at least one solution parameter further comprises: sending, via an application programming interface, the request from the avatar to the micro-service based on the input ingestible by the avatar; and receiving, via the metaverse space, the at least one solution parameter based on an output generated by the micro-service.

Example 15 is the method of example 9, wherein outputting the at least one solution parameter in the metaverse space further comprises displaying, for the entity, the at least one solution parameter proximate to the avatar in the metaverse space.

Example 16 is a non-transitory computer-readable medium comprising instructions that are executable by a processing device for causing the processing device to perform operations comprising: receiving, via an avatar in a metaverse space, a query from an entity relating to a wellbore operation, the avatar including a software application for performing tasks in the metaverse space, the metaverse space including a computer-generated representation of a location related to the wellbore operation, the metaverse space usable to communicatively couple data from a real-world wellbore operation and at least one micro-service; executing, via the avatar, a request to the at least one micro-service for at least one solution parameter for the wellbore operation based on the query; receiving, via the metaverse space, the at least one solution parameter from the at least one micro-service; and outputting the at least one solution parameter for display in the metaverse space, the at least one solution parameter usable to adjust the wellbore operation.

Example 17 is the non-transitory computer-readable medium of example 16, wherein the operation of executing, via the avatar, the request to the at least one micro-service for the at least one solution parameter further comprises: providing, via the metaverse space, real-time data of the wellbore operation to the micro-service for predicting at least one optimized parameter relating to the wellbore operation; and simulating, via the metaverse space, at least one scenario relating to the wellbore operation.

Example 18 is the non-transitory computer-readable medium of example 16, further comprising the operation of providing access to the metaverse space for the entity by: providing access to the metaverse space via virtual reality technology or augmented reality technology; and generating, via the virtual reality technology or the augmented reality technology, a virtual rig or a virtual office, wherein the virtual rig or the virtual office includes at least one avatar.

Example 19 is the non-transitory computer-readable medium of any of examples 16 and 18, wherein the operations further comprise providing access to the metaverse space for the entity using a blockchain by: partitioning at least one set of data for access by a particular entity; generating a particular metaverse space, the particular metaverse space including the at least one set of data; and providing, via an authentication process, access to the particular metaverse space and the at least one set of data for the particular entity, wherein the authentication process includes the particular entity providing an authorization credential and permitting the particular entity to enter to the particular metaverse space.

Example 20 is the non-transitory computer-readable medium of example 16, further comprising adjusting the wellbore operation autonomously by: receiving the at least one solution parameter via the metaverse space, determining an adjustment to the wellbore operation based on the at least one solution parameter; and adjusting the wellbore operation based on the adjustment.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processor; and
a non-transitory computer-readable medium that includes instructions executable by the processor for causing the processor to perform operations comprising:
receiving, via an avatar in a metaverse space, a query from an entity relating to a wellbore operation, the avatar including a software application for performing tasks in the metaverse space, the metaverse space including a computer-generated representation of a location related to the wellbore operation, the metaverse space usable to communicatively couple data from a real-world wellbore operation and at least one micro-service;
executing, via the avatar, a request to the at least one micro-service for at least one solution parameter for the wellbore operation based on the query;
receiving, via the metaverse space, the at least one solution parameter from the at least one micro-service; and
outputting the at least one solution parameter for display in the metaverse space, the at least one solution parameter usable to adjust the wellbore operation.

2. The system of claim 1, wherein the operation of executing, via the avatar, the request to the at least one micro-service for the at least one solution parameter further comprises:
providing, via the metaverse space, real-time data of the wellbore operation to the at least one micro-service for predicting at least one optimized parameter relating to the wellbore operation; and
simulating, via the metaverse space, at least one scenario relating to the wellbore operation.

3. The system of claim 1, further comprising the operation of providing access to the metaverse space for the entity by:
providing access to the metaverse space via virtual reality technology or augmented reality technology; and
generating, via the virtual reality technology or the augmented reality technology, a virtual rig or a virtual office, wherein the virtual rig or the virtual office includes at least one avatar.

4. The system of claim 3, wherein the operations further comprise providing access to the metaverse space for the entity using a blockchain by:
partitioning at least one set of data for access by a particular entity;
generating a particular metaverse space, the particular metaverse space including the at least one set of data; and
providing, via an authentication process, access to the particular metaverse space and the at least one set of data for the particular entity, wherein the authentication process includes the particular entity providing an authorization credential and permitting the particular entity to enter to the particular metaverse space.

5. The system of claim 1, wherein the operation of receiving, via the avatar in the metaverse space, the query further comprises:
performing natural language processing on the query for generating an input ingestible by the avatar in the metaverse space;
transmitting the input ingestible by the avatar from the entity to the avatar in the metaverse space;
transmitting the input ingestible by the avatar from the avatar in the metaverse space to the at least one micro-service; and
determining the at least one micro-service to access based on the input ingestible by the avatar.

6. The system of claim 5, wherein the operation of executing, via the avatar, the request to the at least one micro-service for the at least one solution parameter further comprises:
transmitting, via an application programming interface, the request from the avatar to the micro-service based on the input ingestible by the avatar; and
receiving the at least one solution parameter based on an output from the micro-service.

7. The system of claim 1, wherein the operation of outputting the at least one solution parameter for display in the metaverse space further comprises displaying, for the entity, the at least one solution parameter proximate to the avatar in the metaverse space.

8. The system of claim 1, further comprising the operation of adjusting the wellbore operation autonomously by:
receiving the at least one solution parameter via the metaverse space,
determining an adjustment to the wellbore operation based on the at least one solution parameter; and
adjusting the wellbore operation based on the adjustment.

9. A method comprising:
receiving, via an avatar in a metaverse space, a query from an entity relating to a wellbore operation, the avatar including a software application for performing tasks in the metaverse space, the metaverse space including a computer-generated representation of a location related to the wellbore operation, the metaverse space usable to communicatively couple data from a real-world wellbore operation and at least one micro-service;
executing, via the avatar, a request to the at least one micro-service for at least one solution parameter for the wellbore operation based on the query;
receiving, via the metaverse space, the at least one solution parameter from the at least one micro-service; and
outputting the at least one solution parameter for display in the metaverse space, the at least one solution parameter usable to adjust the wellbore operation.

10. The method of claim 9, wherein executing, via the avatar, the request to the at least one micro-service for the at least one solution parameter further comprises:
providing, via the metaverse space, real-time data of the wellbore operation to the at least one micro-service for predicting at least one optimized parameter relating to the wellbore operation; and
simulating, via the metaverse space, at least one scenario relating to the wellbore operation.

11. The method of claim 9, further comprising providing access to the metaverse space for the entity by:
providing access to the metaverse space via virtual reality technology or augmented reality technology; and
generating, via the virtual reality technology or the augmented reality technology, a virtual rig or a virtual office, wherein the virtual rig or the virtual office includes at least one avatar.

12. The method of claim 11, further comprising providing access to the metaverse space for the entity using a blockchain by:
partitioning at least one set of data for access by a particular entity;
generating a particular metaverse space, the particular metaverse space including the at least one set of data; and
providing, via an authentication process, access to the particular metaverse space and the at least one set of data for the particular entity, wherein the authentication process includes the particular entity providing an authorization credential and permitting the particular entity to enter to the particular metaverse space.

13. The method of claim 9, wherein receiving, via the avatar in the metaverse space, the query from the entity further comprises:
performing natural language processing on the query for generating an input ingestible by the avatar in the metaverse space;
transmitting the input ingestible by the avatar from the entity to the avatar in the metaverse space;
transmitting the input ingestible by the avatar from the avatar in the metaverse space to the micro-service; and
determining the micro-service to access based on the input ingestible by the avatar.

14. The method of claim 13, wherein executing, via the avatar, the request to the at least one micro-service for the at least one solution parameter further comprises:
sending, via an application programming interface, the request from the avatar to the micro-service based on the input ingestible by the avatar; and
receiving, via the metaverse space, the at least one solution parameter based on an output generated by the micro-service.

15. The method of claim 9, wherein outputting the at least one solution parameter in the metaverse space further comprises displaying, for the entity, the at least one solution parameter proximate to the avatar in the metaverse space.

16. A non-transitory computer-readable medium comprising instructions that are executable by a processing device for causing the processing device to perform operations comprising:
receiving, via an avatar in a metaverse space, a query from an entity relating to a wellbore operation, the avatar including a software application for performing tasks in the metaverse space, the metaverse space including a computer-generated representation of a location related to the wellbore operation, the metaverse space usable to communicatively couple data from a real-world wellbore operation and at least one micro-service;
executing, via the avatar, a request to the at least one micro-service for at least one solution parameter for the wellbore operation based on the query;
receiving, via the metaverse space, the at least one solution parameter from the at least one micro-service; and
outputting the at least one solution parameter for display in the metaverse space, the at least one solution parameter usable to adjust the wellbore operation.

17. The non-transitory computer-readable medium of claim 16, wherein the operation of executing, via the avatar, the request to the at least one micro-service for the at least one solution parameter further comprises:
providing, via the metaverse space, real-time data of the wellbore operation to the micro-service for predicting at least one optimized parameter relating to the wellbore operation; and
simulating, via the metaverse space, at least one scenario relating to the wellbore operation.

18. The non-transitory computer-readable medium of claim 16, further comprising the operation of providing access to the metaverse space for the entity by:
providing access to the metaverse space via virtual reality technology or augmented reality technology; and
generating, via the virtual reality technology or the augmented reality technology, a virtual rig or a virtual office, wherein the virtual rig or the virtual office includes at least one avatar.

19. The non-transitory computer-readable medium of claim 18, wherein the operations further comprise providing access to the metaverse space for the entity using a blockchain by:
partitioning at least one set of data for access by a particular entity;
generating a particular metaverse space, the particular metaverse space including the at least one set of data; and
providing, via an authentication process, access to the particular metaverse space and the at least one set of data for the particular entity, wherein the authentication process includes the particular entity providing an authorization credential and permitting the particular entity to enter to the particular metaverse space.

20. The non-transitory computer-readable medium of claim 16, further comprising adjusting the wellbore operation autonomously by:
receiving the at least one solution parameter via the metaverse space,
determining an adjustment to the wellbore operation based on the at least one solution parameter; and
adjusting the wellbore operation based on the adjustment.
